(19) United States
(12) Patent Application Publication
(10) Pub. No.: US 2006/0021274 A1
(43) Pub. Date: Feb. 2, 2006

(54) Insect killer

(76) Inventor: Ding Ran Chen, Chia Yi Hsien (TW)

Correspondence Address: Keith Kline;PRO-TECHTOR INTERNATIONAL SERVICES, 20775 Norada Court, Saratoga, CA, 95070-3018, US

(21) Appl. No.: 10/900,677

(22) Filed: Jul. 27, 2004

(51) Int. Cl. A01M 1/22; A01M 1/04; A01M 1/02

(52) U.S. Cl. 43/112; 43/113; 43/107

(57) ABSTRACT

An insect killer using a fluorescent light source to attract biting insect and an electrified grid to kill biting insect is disclosed to have light reflecting mirrors that reflect light from the fluorescent light source, and electric heating elements that produce heat energy to attract biting insects.

### BACKGROUND OF THE INVENTION

1. Field of the Invention

The present invention relates to insect killers and more particularly, to such an insect killer that uses reflecting mirrors to reflect light from the fluorescent light source and electric heating elements to produce heat to further attract biting insects.

2. Description of the Related Art

Mosquitoes are annoying biting insects that cause serious problem to human beings. Mosquitoes can be carriers of many diseases in humans. Mosquitoes also transmit heartworms to cats and dogs. People may spray or apply chemical to kill biting insects. However, these chemicals often have a deleterious effect on the environment, and are effective only for a short time. Therefore, various insect killers are developed. These insect killers commonly use a fluorescent light source to attract biting insects and an electrified grid or carbon dioxide to kill biting insects. Similar designs are seen in U.S. Pat. Nos. 5,595,018; 6,594,946; 6,655,078. However, the light of a fluorescent light source may be insufficient to attract all surrounding biting insects.

### SUMMARY OF THE INVENTION

The present invention has been accomplished under the circumstances in view. It is one object of the present invention to provide an insect killer, which enhances the amount of lighting to attract biting insects. It is another object of the present invention to provide an insect killer, which produces heat to attract biting insects. To achieve these and other objects of the present invention, the insect killer comprises a base, a top shell spaced above the base, a grille connected between the base and the top shell around the border area thereof, a fluorescent light source mounted in the center of the base and surrounded by the grille, an electrified grid mounted in the base and surrounded by the grille around the fluorescent light source, a power cord adapted to receive power supply for working of the electrified grid and the fluorescent light, a plurality of reflecting mirrors arranged around the fluorescent light source and surrounded by the grille for reflecting light from the fluorescent light source to enhance the amount of lighting, and a plurality of electric heating elements installed the reflecting mirrors and electrically connected to the power cord to produce heat to attract biting insects upon connection of the power cord to power supply. The electric heating elements can be electric heating plates or coils. The reflecting mirrors may be arranged in vertical or in a sloping position.

### BRIEF DESCRIPTION OF THE DRAWINGS

FIG. 1 is an exploded view of an insect killer according to the present invention.

FIG. 2 is an assembly view of the insect killer shown in FIG. 1.

FIG. 3 is a top view showing one installation example of the reflecting mirrors in the inset killer according to the present invention.

FIG. 4 is a top view showing another installation example of the reflecting mirrors in the inset killer according to the present invention.

FIG. 5 is a schematic side view showing still another installation example of the reflecting mirrors in the inset killer according to the present invention.

FIG. 6 is an exploded view of an alternate form of the present invention.

FIG. 7 is a schematic plain view showing electric heating plates arranged on the reflecting mirror according to the present invention.

FIG. 8 is a schematic plain view showing electric heating coils arranged on the reflecting mirror according to the present invention.

FIG. 9 is a schematic side view showing heat-resisting films covered on heat absorbing members at the reflecting mirror according to the present invention.

### DETAILED DESCRIPTION OF THE PREFERRED EMBODIMENT

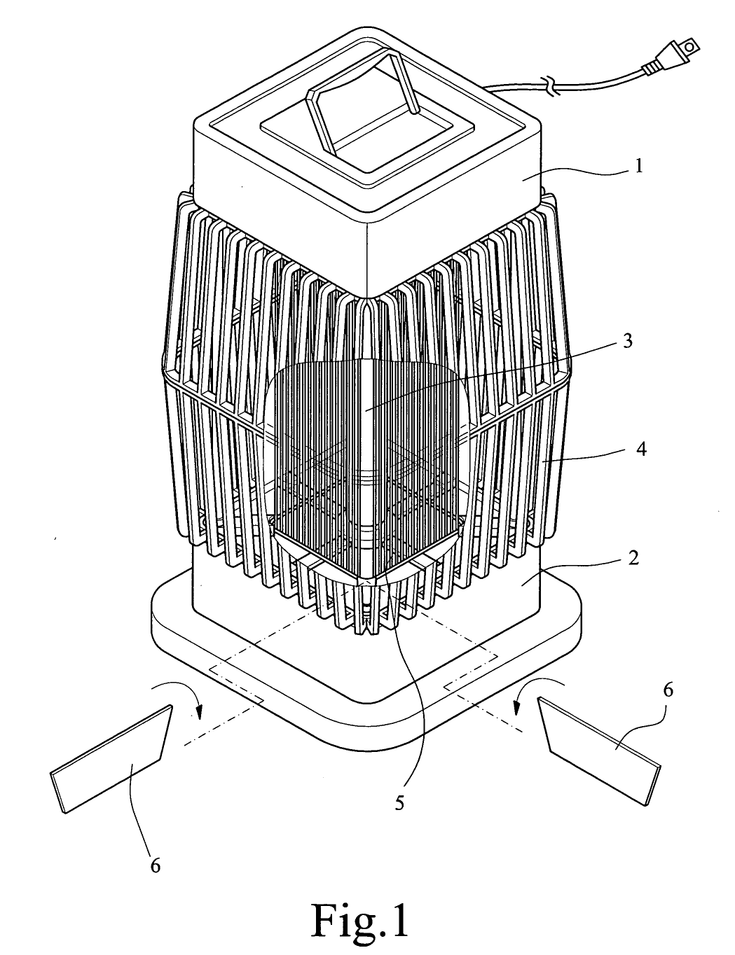

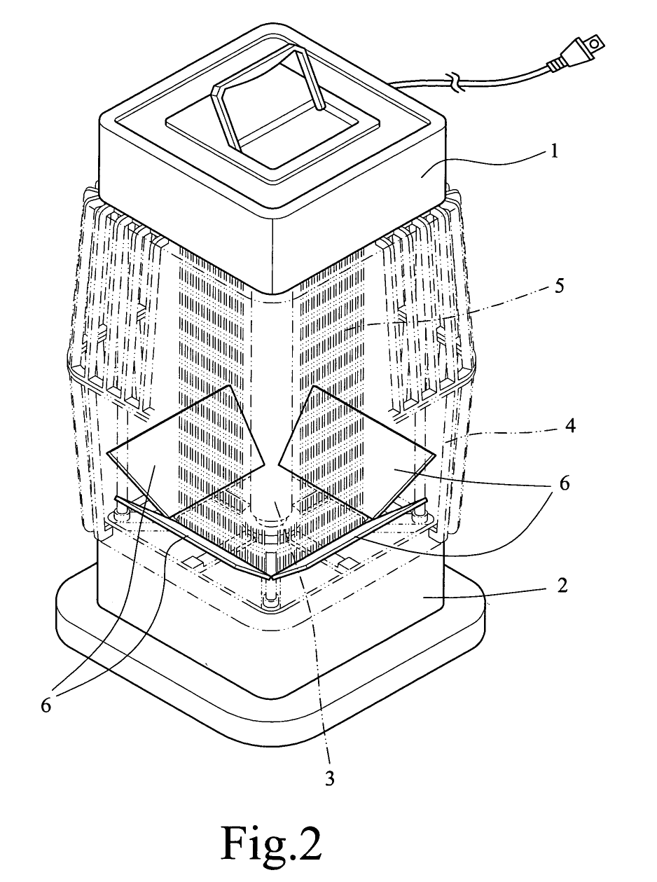

Referring to FIGS. 1 and 2, an insect killer in accordance with the present invention is shown comprising a base 2, a top shell 1 spaced above the base 2, a grille 4 connected between the base 2 and the top shell 1 around the border area thereof, a fluorescent light source 3 mounted in center of the base 2 and surrounded by the grille 4, an electrified grid 5 mounted in the base 2 and surrounded by the grille 4 around the fluorescent light source 3, and a plurality of reflecting mirrors 6 spaced around the fluorescent light source 3 and surrounded by the grille 4 for reflecting light from the fluorescent light source 3.

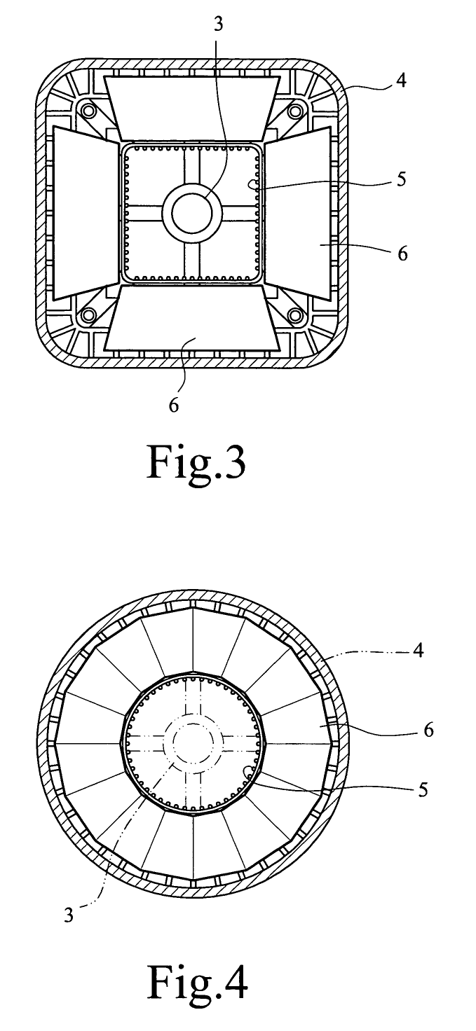

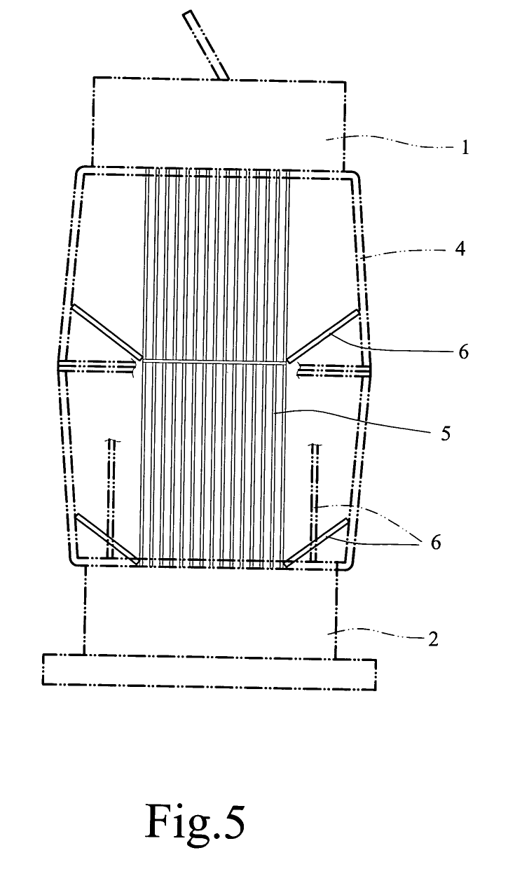

Referring to FIGS. 3˜5 and FIGS. 1 and 2 again, the reflecting mirrors 6 may be various embodied. According to the embodiment shown in FIG. 3, four reflecting mirrors 6 arranged at four sides around the fluorescent light source 3. According to the embodiment shown in FIG. 4, a plurality of reflecting mirrors 6 are abutted one against another around the fluorescent light source 3. According to the embodiment shown in FIG. 5, the reflecting mirrors 6 are arranged into two sets that are disposed at different elevations around the fluorescent light source 3. The reflecting mirrors 6 may be set in vertical or arranged in a tilted position. The reflecting mirrors 6 can be set in the space between the fluorescent light source 3 and the electrified grid 5, or in the space between the grille 4 and the electrified grid 5.

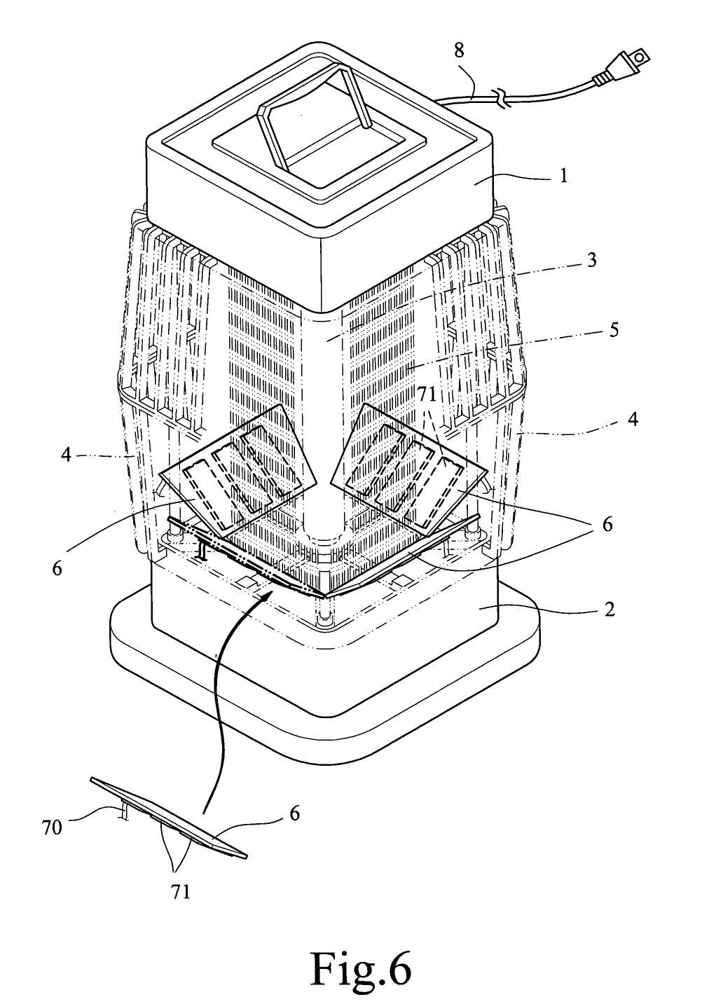

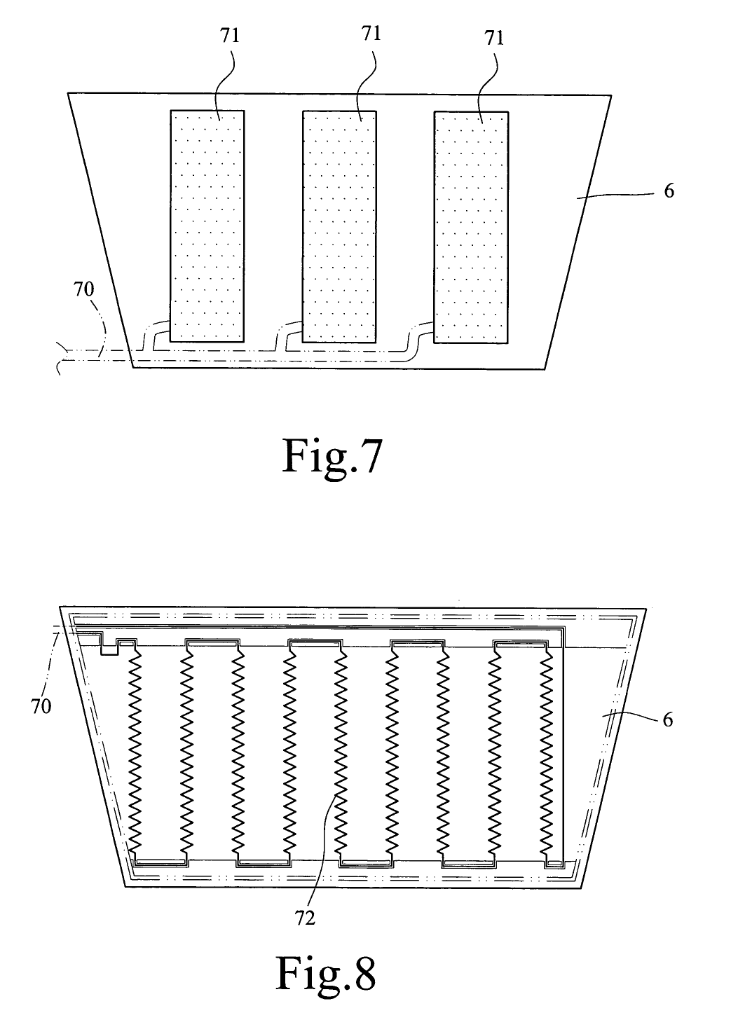

Referring to FIGS. 6˜8, electric heating plates 71 (see FIGS. 6 and 7) or electric heating coils 72 (see FIG. 8) may be provided at the back side of each of the reflecting mirrors 6 and connected to the power cord 8 of the insect killer by an electric wire 70.

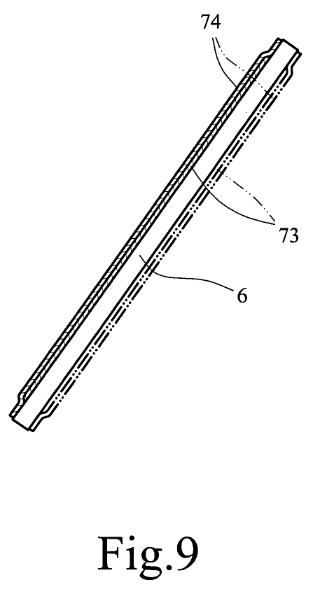

Referring to FIG. 9, heat-resisting films 74 may be covered on each reflecting mirror 6 to secure heat-absorbing members 73 to the front and/or back side of each reflecting mirror 6.

Referring to FIGS. 1˜9 again, upon connection of the power cord 8 to city power supply, the fluorescent light source 3 is turned on to give off light, the reflecting mirrors 6 reflect light from the fluorescent light source 3 to attract mosquitoes and biting insects. Upon flying to the light, mosquitoes and biting insects will be electrocuted by the electrified grid 5. Further, the electric heating plates 72 or electric heating coils 72 are simultaneously turned on upon connection of the power cord 8 to city power supply, thereby producing heat to attract mosquitoes and biting insects. In case heat absorbing members 73 are used with the reflecting mirrors 6, they absorb heat energy from the fluorescent light source 3, keeping the inside space of the insect killer warm

A prototype of insect killer has been constructed with the features of FIGS. 1˜9. The insect killer functions smoothly to provide all of the features discussed earlier.

Although particular embodiments of the invention have been described in detail for purposes of illustration, various modifications and enhancements may be made without departing from the spirit and scope of the invention.

What the invention claimed is:

1. An insect killer comprising a base, a top shell spaced above said base, a grille connected between said base and said top shell around the border area thereof, a fluorescent light source mounted in the center of said base and surrounded by said grille, an electrified grid mounted in said base and surrounded by said grille around said fluorescent light source, and a power cord adapted to receive power supply for working of said electrified grid and said fluorescent light, wherein reflector means is provided and spaced around said fluorescent light source and surrounded by said grille for reflecting light from said fluorescent light source, having electric heating elements installed therein and electrically connected to said power cord.

2. The insect killer as claimed in claim 1, wherein said reflector means is comprised of at least one reflecting mirror sloping in one direction.

3. The insect killer as claimed in claim 1, wherein said reflector means is comprised of at least one reflecting mirror respectively set in vertical.

4. The insect killer as claimed in claim 1, wherein said reflector means is comprised of a plurality of reflecting mirrors set in between said fluorescent light source and said electrified grid.

5. The insect killer as claimed in claim 1, wherein said reflector means is comprised of a plurality of reflecting mirrors set in between said grille and said electrified grid.

6. The insect killer as claimed in claim 1, wherein said electric heating elements are electric heating plates.

7. The insect killer as claimed in claim 1, wherein said electric heating elements are electric heating coils.
